(19) United States
(12) Patent Application Publication
(10) Pub. No.: US 2014/0008191 A1
(43) Pub. Date: Jan. 9, 2014

(54) PORTABLE TERMINAL WITH SIDE KEY

(71) Applicant: SAMSUNG ELECTRONICS CO., LTD., Gyeonggi-do (KR)

(72) Inventors: Jung-Woong HYUN, Gyeongsangbuk-do (KR); Su-Kyu LEE, Busan (KR)

(73) Assignee: Samsung Electronics Co., Ltd., Gyeonggi-do (KR)

(21) Appl. No.: 13/859,161

(22) Filed: Apr. 9, 2013

(30) Foreign Application Priority Data
Jul. 9, 2012 (KR) 10-2012-0074386

(51) Int. Cl. H01H 13/86

(52) U.S. Cl. CPC H01H 13/86
USPC 200/295

(57) ABSTRACT

A portable terminal includes a housing, a key member movably coupled to the housing and exposed to a side of the housing, and a board arranged to be opposed to the inner surface of the key member. The board is coupled to the housing and serves to restrain the key member within the housing, so that the key member is prevented from breaking out from the housing during the assembly process.

### CLAIM OF PRIORITY

This application claims the priority under 35 U.S.C. §119(a) to an earlier Korean Application Serial No. 10-2012-0074386, which was filed in the Korean Intellectual Property Office on Jul. 9, 2012, the entire content of which is hereby incorporated by reference.

### BACKGROUND OF THE INVENTION

1. Field of the Invention

The present invention relates a portable terminal, and more particularly, to a portable terminal with a side key that is convenient to assemble.

2. Description of the Related Art

A portable terminal provides a variety of services including voice communication or short message transmission, a data communication function, such as Internet, mobile banking, or multimedia file transmission, and a multimedia function, such as game or reproduction of music or a moving picture while the user is carrying the portable terminal

A portable terminal typically includes a keypad and a microphone as input devices, and a display device and a speaker as output devices. Recently, as a touch screen function is implemented as an input unit, a physical keypad is no longer available. However, a power key, a two-way key for volume tuning, a camera shutter key, etc. are still implemented using physical keys on a side of the touch screen devices.

FIG. 1 illustrates a part of a conventional portable terminal 100 including side keys. As shown, a side key installed in the conventional portable terminal 100 includes a key member 113a or 113b inserted into a slot formed in a housing 101 and a board 115a or 115b. The board 115a or 115b is arranged in the inside of the key member 113a or 113b, and a dome switch (not illustrated) is provided on the board 115a or 115b. The board 115a or 115b is typically a flexible printed circuit board and connected to a main circuit board 111 installed within the housing 101.

The above side keys are configured such that the boards 115a and 115b and the key members 113a and 113b are independently assembled. However, there is a problem in that the key members 113a and 113b easily break out from the housing 101 during the assembly process. Some products employ an adhesive member for temporarily fixing the housing 101 and the key members 113a and 113b, for example, a vinyl tape, in order to prevent the key members 113a and 113b from breaking out from the housing 101 during fabrication. However, this has drawbacks in that material costs and working time are undesirably increased.

As another method for preventing breaking-out of the key members 113a and 113b, a flexible silicon member is dual injection-molded to the key members 113a and 113b, and the silicon member is fixed to the housing 101 by a separate structure. However, there are disadvantages in that it requires an extra process for dual injection-molding the silicon member, and also it is complicated to assemble the key members with a separate structure. Furthermore, a process for fixing the silicon member to the housing, for example, an ultrasonic welding has to be added, thus generating an extra fabrication step and costs.

### SUMMARY OF THE INVENTION

Accordingly, an aspect of the present invention is to solve at least the above-described problems occurring in the prior art, and to provide at least the advantages described below.

Another aspect of the present invention is to provide a portable terminal configured such that a side key can be easily assembled.

Also, another aspect of the present invention is to provide a portable terminal configured to be capable of preventing a key member of a side key from breaking out from a housing during the assembly process while allowing easy assembling of the side key.

Still another aspect of the present invention is to provide a portable terminal having a side key configured to lower the material costs, and also easy and convenient to assemble, thereby contributing an increase in the productivity.

In accordance with another aspect of the present invention, a portable terminal includes: a housing; a key member movably coupled to the housing and disposed on a side of the housing; and a board arranged to be opposed to the inner surface of the key member. The board is coupled to the housing and serves to restrain the key member within the housing.

### BRIEF DESCRIPTION OF THE DRAWINGS

The above and other aspects, features, and advantages of the present invention will be more apparent from the following detailed description taken in conjunction with the accompanying drawings, in which:

FIG. 1 is an exploded perspective view illustrating a part of a conventional portable terminal including side keys.

FIG. 2 is a perspective view illustrating a part of a portable terminal according to an exemplary embodiment of the present invention.

FIG. 3 is a partially cutaway view illustrating a side key arranged on one side of a housing among the side keys of the portable terminal depicted in FIG. 2;

FIG. 4 is a perspective view illustrating the key member of the side key depicted in FIG. 3;

FIG. 5 is a perspective view illustrating the board of the side key depicted in FIG. 3;

FIG. 6 is a partially cutaway view illustrating a key member arranged on the other side of the housing among the side keys of the portable terminal depicted in FIG. 2;

FIG. 7 is a perspective view illustrating the key member of the side key depicted in FIG. 6; and

FIG. 8 is a perspective view illustrating the board of the side key depicted in FIG. 6.

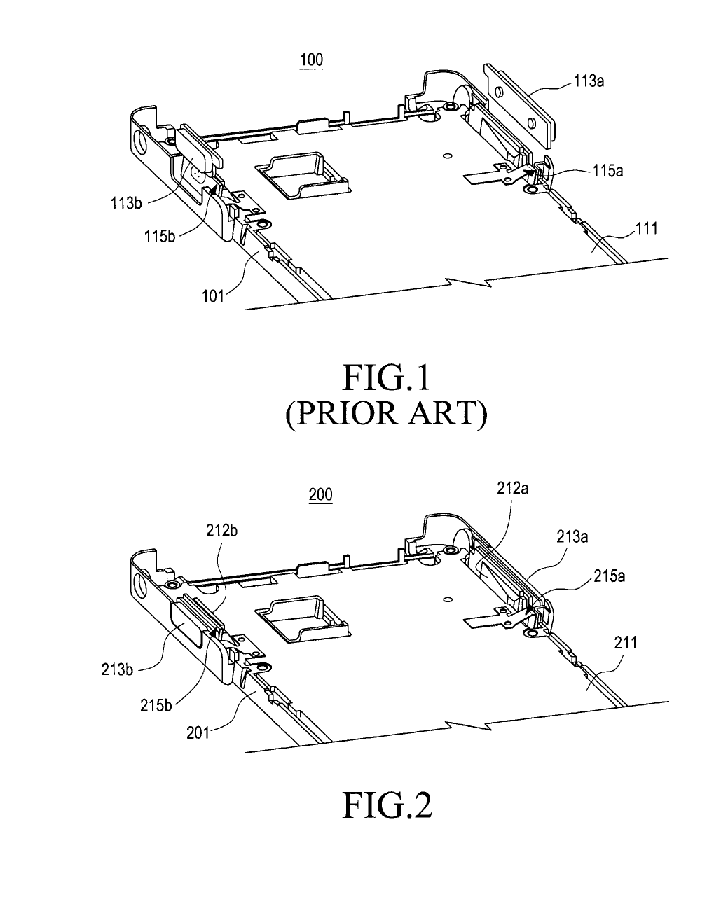

### DETAILED DESCRIPTION OF THE INVENTION

Hereinafter, various embodiments of the present invention will be described with reference to the accompanying drawings. For the purposes of clarity and simplicity, a detailed description of known functions and configurations incorporated herein will be omitted as it may make the subject matter of the present invention unclear.

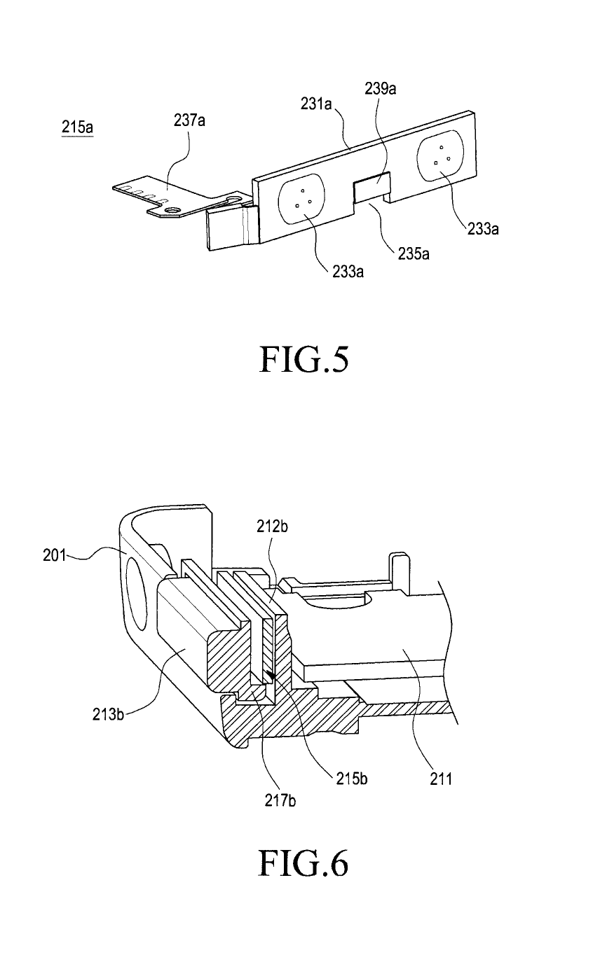

FIG. 2 is a perspective view illustrating a part of a portable terminal according to an exemplary embodiment of the present invention. As shown, the portable terminal 200 includes side keys installed on the sides of a housing 201, in which each of the side keys may include one switch member or one pair of switch members 233a or 233b (shown in FIGS. 5 and 8). In the configuration illustrated in FIG. 2, a first side key arranged on one side of the housing 201 includes one pair of switch members 233a (shown in FIG. 5), and a second side key arranged on the other side includes one switch member 233b (shown in FIG. 8).

The housing 201 accommodates a main circuit board 211 inside thereof and includes slots configured to install the side keys thereto. Such a “slot” is generally formed in a form of an opening. However, in an exemplary embodiment of the present invention, support ribs 212a and 212b are formed on the opposed inner side walls of the housing 201 such that spaces between the inner side walls of the housing 201 and the support ribs 212a and 212b are used as the slots. That is, the side keys are disposed between the inner side walls of the housing 201 and the support ribs 212a and 212b, respectively.

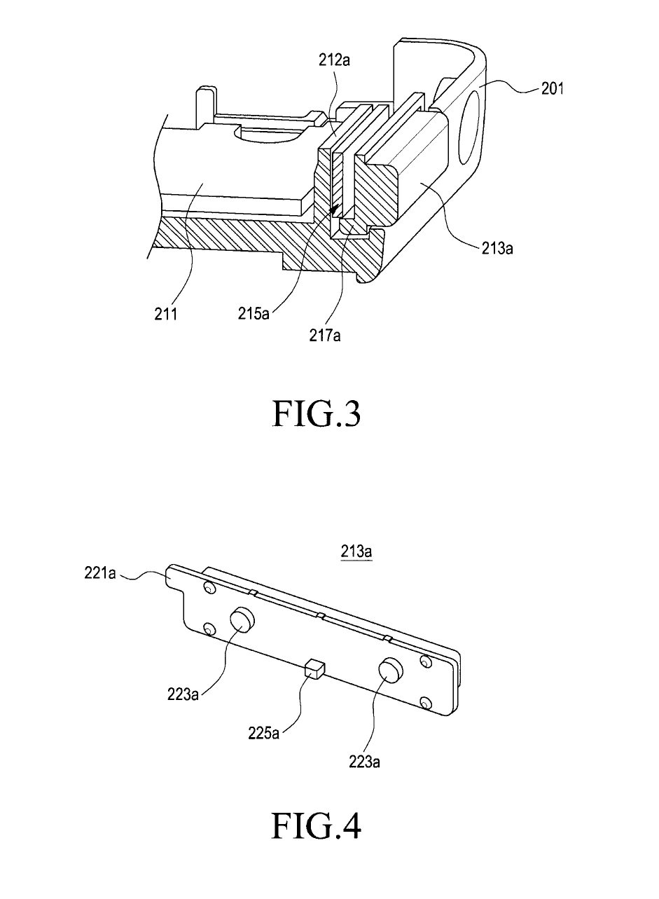

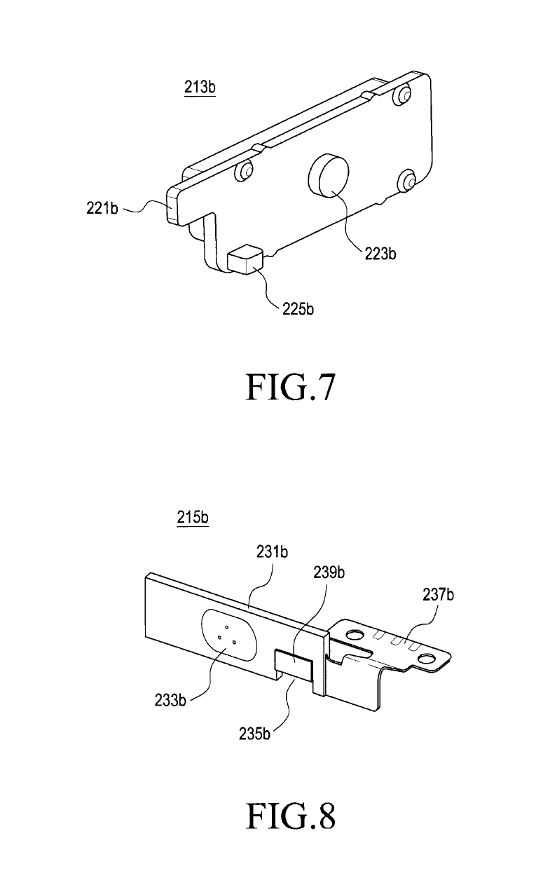

FIGS. 3 and 6 illustrate the side keys installed in the housing 201 in partially cutaway views, respectively, FIGS. 4 and 7 illustrate the key members 213a and 213b of the side keys, respectively, and FIGS. 5 and 8 illustrate the boards 215a and 215b of the side keys, respectively.

Referring to FIGS. 3 and 6, the key members 213a and 213b are configured to be directly manipulated by a user, and when arranged in the housing 201, to be exposed to the outside of the housing 201 on the outer surfaces thereof Each of the key members 213a and 213b is formed with actuation studs 223a or 223b on the inner surface thereof.

Referring to FIG. 4, the key member 213a of the first key (hereinafter, referred to as a “first key member”) is formed with a pair of actuation studs 223a, and the key member 213b of the first key (hereinafter, referred to as a “first key member”) is formed with a pair of actuation studs 223b. The first key member 213a formed with the pair of actuation studs 223a is adapted to conduct functions, such as a volume tuning, a screen brightness adjustment, and a menu shift.

Referring to FIG. 7, the second key member 213b formed with one actuation stud 223b is used as a hot key for conducting specific functions, such as a power ON/OFF function, a camera mode activation, and a shutter function. Of course, the first key member 213a may also be provided with such hot key functions. For example, a current time notification function, a screen locking and unlocking function or the like may be provided. This is determined by properly selecting signals assigned by a designer to each of the switch members when designing a practical product, thus any combination of actuation studs can be designated to the respective key member.

Meanwhile, referring to FIGS. 4 and 7, at an inner edge of each of the key members 213a and 213b a support piece 221a or 221b may be formed. The support pieces 221a and 221b are supported by the inner surfaces of the housing 201 to prevent the key members 213a, 213b from breaking out to the outside of the housing 201. As such, the key members 213a and 213b are arranged between the inner wall of the housing 201 and the support ribs 212a and 212b in such a manner that they can be prevented from being completely penetrated into the outside of the housing 201 or breaking out to the outside of the housing 201. That is, the key members 213a and 213b are movable on the housing 201 within a limited range.

Referring to FIGS. 5 and 8, the boards 215a and 215b are preferably formed as substantially flexible printed circuit boards. Because the flexible printed circuit boards are relatively freely deformable in shape, the boards 215a and 215b may be easily arranged in the slots, i.e. between the inner wall of the housing 201 and the support ribs 211a and 211b. Each of the boards 215a and 215b is arranged between the inner surface of one of the key members 213a and 213b and the support ribs 212a and 212b. The switch members 233a and 233b are arranged on the boards 215a and 215b to be opposed to the inner surfaces of the key member 213a and 213b, more specifically, the actuation studs 223a and 223b, respectively.

Accordingly, when the user pushes the key members 213a and 213b, the corresponding switch members 233a and 233b are actuated to produce a signal. Here, tact switches or dome switches are frequently used as the switch members 233a and 233b. However, in the exemplary embodiment of the present invention, because the boards 215a and 215b are arranged in the narrow spaces between the inner surfaces of the key members 213a and 213b and the support ribs 212a and 212b, dome switches, which are relatively thin, may be preferably used as the switch members 233a and 233b. Each of the boards 215a and 215b includes an operation section board 231a or 231b where the switches 233a or the switch 233b are arranged, and a connection section board 237a or 237b from the operation section board 231a or 231b, in which the operation section boards 231a and 231b are arranged to be opposed to the inner walls of the slots, more specifically, the support ribs 212a and 212b, respectively, and the connection section boards 237a and 237b are fixed to the main circuit board 211. The connection section boards 237a and 237b may be completely fixed to the main circuit board 211 by a soldering type, and in some exemplary embodiments, may be fixed to the circuit board 211 by a connector type.

Meanwhile, referring to FIGS. 4 and 7, in order to prevent the key members 213a and 213b from breaking out in a direction opposite to the insertion direction of the key members 213a and 213b into the slots in the state where the key members 213a and 213b are inserted into the slots, each of the side keys includes a restraint protrusion 225a or 225b and a notch 235a or 235b. The restraint protrusions 225a and 225b protrude from edges of the inner surfaces of the key members 213a and 213b, respectively, in which when the key members 213a and 213b are arranged on the housing 201, the restraint protrusions 225a and 225b are positioned to be directed to the inside of the housing 201. In the first key member 213a, on which the pair of actuation studs 223a and 223b are formed, it is preferred that the restraint protrusion 225a is formed at an edge of the inner surface of the first key member 213a between the actuation studs 223a and 223b. Each of the notches 235a and 235b is formed on one of the boards 215a and 215b, more specifically, at an edge of one of the operation section boards 231a and 231b. Each of the notches 235a and 235b are formed in one of the boards 215a and 215b, more specifically at an edge of one of the operation section boards 231a and 231b to positionally correspond to one of the restraint protrusions 225a and 225b. As such, when the key members 213a and 213b and the boards 215a and 215b are arranged in the slots, respectively, the notches 235a and 235b will accommodate or receive the restraint protrusions 225a and 225b, respectively.

The restraint protrusions 225a and 225b and the notches 235a and 235b are structures for preventing the key members 213a and 213b from breaking out in the process of the portable terminal 200. Accordingly, it is preferred that the restraint protrusions 225a and 225b are arranged close to the bottoms of the slots when they are arranged in the slots. If the restraint protrusions 225a and 225b are arranged close to the bottoms of the slots, the restraint protrusions 225a and 225b are surrounded by the notches 235a and 235b and the bottoms of the slots when the boards 215a and 215b are arranged in the slots. As such, the key members 213a and 213b are restrained in the slots by the boards 215a and 215b, respectively.

Meanwhile, when the key members 213a and 213b are required to be replaced due to damage or the like, only a key member to be replaced can be removed from the correspond slot. In the process of removing the key member from the corresponding slot, the corresponding board 215a or 215b is also removed from the corresponding slot. This is because the restraint protrusions 225a and 225b move the boards 215a and 215b in the directions of breaking out from the slots while the key members 213a and 213b are breaking out from the slots. In that event, if the boards 215a and 215b are interfered with another structure or fastened to the insides of the slots, the boards 215a and 215b may be damaged by the restraint protrusions 225a and 225b. In order to prevent the damage of the boards 215a and 215b, reinforcement members 239a and 239b may be attached to the boards 215a and 215b. It is preferred that the reinforcement members 239a and 239b are attached to both sides of the boards 215a and 215b around the notches 235a and 235b, specifically, while wrapping the inner walls of the notches 235a and 235b opposed to the restraint protrusions 225a and 225b, more specifically, while wrapping the inner walls of the notches 235a and 235b directly interfered with the restraint protrusions 225a and 225b while the key members are breaking out. Here, a transparent tape, a metal foil, for example, an aluminum foil or a copper foil, may be used as such a reinforcement member.

Having thus described a preferred embodiment as above, it should be apparent to those skilled in the art that certain advantages have been achieved. In particular, the portable terminal having the side keys as described above may prevent the key members from breaking out from the housing merely by arranging the key members of the side keys in the slots formed in the housing and then assembling the boards corresponding to the key members to the slots. Accordingly, the side keys can be easily installed in the narrow spaces in the portable terminal, and the decreasing of productivity due to the breaking-out of the key members in the process of assembling can be prevented. Moreover, because no separate assemble configuration or process is added or required as in the prior art which in turn reduces the assembling sequence, the present invention can improve assemblability and productivity while lowering the manufacturing costs.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A portable terminal comprising:
a housing;
at least one key member movably displaced within the housing and being exposed to an exterior; and
at least one board arranged to be opposed to an inner surface of the key member,
wherein the at least one board is coupled to the housing and restrains the at least one key member within the housing.

2. The portable terminal of claim 1, further comprising:
one or more actuation studs formed on the inner surface of the key member; and
one or more switch members installed on the at least one board,
wherein the switch members are arranged to be opposed to the actuation stud.

3. The portable terminal of claim 2, wherein one pair of the actuation studs is aligned with one pair of the switching members of the at least one board.

4. The portable terminal of claim 2, wherein the switch members are dome switches.

5. The portable terminal of claim 1, further comprising:
a main circuit board arranged in the housing,
wherein the at least one board is a flexible printed circuit board fixed to the main circuit board.

6. The portable terminal of any of claims 1, further comprising:
a restraint protrusion protruding from an edge on the inner surface of the at least one key member; and
a notch formed at an edge of the at least one board,
wherein the restraint protrusion received in the notch.

7. The portable terminal of claim 6, wherein one pair of the actuating studs are formed on the inner surface of the at least one key member, and the restraint protrusion is positioned between the actuating studs.

8. The portable terminal of claim 6, further comprising:
a slot formed on a side of the housing,
wherein the at least one board is arranged between the inner surface of the at least one key member and the inner wall of the slot.

9. The portable terminal of claim 8, wherein the at least one key member is inserted into the slot, and the outer surface of the at least one key member is exposed to a side of the housing.

10. The portable terminal of claim 8, wherein the at least one key member is inserted into the slot, and the restraint protrusion is positioned adjacent to the bottom of the slot.

11. The portable terminal of claim 8, further comprising:
a support rib formed in the inner surface of the housing,
wherein the support rib forms the inner wall of the slot.

12. The portable terminal of claim 6, further comprising:
a reinforcement member around the notch.

13. The portable terminal of claim 12, wherein the reinforcement member is attached to wrap the inner wall of the notch that is opposed to the restraint protrusion.

14. The portable terminal of claim 12, wherein the reinforcement member is any one of a transparent tape, an aluminum foil, and a copper foil.

15. The portable terminal of claim 6, wherein at least one actuating stud is formed on the inner surface of the at least one key member, and the restraint protrusion is positioned adjacent to the at least one actuating stud.

16. The portable terminal of claim 6, further comprising:
at least one actuation stud formed on the inner surface of the key member; and
at least one switch member installed on the at least one board,
wherein the at least one switch members is arranged to be opposed to the at least one actuation stud.
